(19) United States
(12) Patent Application Publication
(10) Pub. No.: US 2020/0394508 A1
(43) Pub. Date: Dec. 17, 2020

(54) CATEGORICAL ELECTRONIC HEALTH RECORDS IMPUTATION WITH GENERATIVE ADVERSARIAL NETWORKS

(71) Applicant: Siemens Aktiengesellschaft, Munchen (DE)

(72) Inventors: Volker Tresp, Munchen (DE); Yinchong Yang, Neubiberg (DE)

(21) Appl. No.: 16/440,102

(22) Filed: Jun. 13, 2019

(51) Int. Cl. G06N 3/08; G06F 16/28

(52) U.S. Cl. CPC G06N 3/08; G06F 16/285

(57) ABSTRACT

The present invention provides an improved method for providing an artificial neural network for data imputation using a generative adversarial network framework. Binary values in categorizing data fields of original data sets are replaced with smoothed-out values that include a degree of randomization but from which the original information can be retrieved. In this way, unintended hints to the discriminating network are minimized and thus the performance of the generative network is improved.

### FIELD OF TECHNOLOGY

In the present era with continued development and innovation in the fields of machine learning and big data, the quality and completeness of data is a major factor. Software tools such as machine learning entities, data sequence miners for pattern recognition and the like are powerful when presented with complete and accurate data sets. Conversely, however, when data sets are incomplete, the predictions may become less reliable or may even fail.

### BACKGROUND

In particular in the medical domain, patient data (often also designated as Electronic Health Records, EHR) are highly useful as inputs and basis for software tools. However, patient data are often incomplete in that the entries for a number of data fields may be missing, for example not every conceivable exam is done on every patient.

It is therefore desired to have techniques to augment, or complete, data by so-called data imputation so as to ideally obtain complete patient data or EHR which can then be used as inputs for software tools such as artificial neural networks and data sequence miners.

In the scientific publication by Yoon et al.: “GAIN: Missing Data Imputation using Generative Adversarial Nets”, arXiv:1806.02920v1 of Jun. 7, 2018 (hereafter cited as “Yoon et al.”, a method is described in which an artificial neural network for data imputation is trained in an generative adversarial network, GAN, framework.

GANs have been introduced in the classic paper by Goodfellow et al.:“Generative Adversarial Networks”, arXiv:1406.2661v1 of Jun. 10, 2014 (hereafter cited as “Goodfellow et al.). The basic idea of the GAN framework is that two networks are being trained against the resistance of the respective other network: a generating network is trained to generate data, and a discriminating network is trained to recognize data generated by the generating network from original data.

By alternating training epochs, or larger training sessions, of the generating network on the one hand and the discriminating network on the other hand, both adversarial networks improve until the discriminating network is no longer able to distinguish generated data from original (or “real”) data. The two adversarial networks may be trained using the same loss function and/or separate loss functions. After sufficient training, in particular when the performance of the discriminating network falls below a target threshold, the generating network can be used as a trained network for generating data.

In Yoon et al., this approach is applied to a generating network which is configured to fill in “missing” data in datasets. A mask matrix is generated which indicates for each input dataset which data fields of the input dataset, if any, are defective, i.e. missing or containing only place-holders. For these data fields, using a randomizing procedure, values are generated, whereas for the data fields that contain original (“real”) data, the values are kept. The generating network is then configured to generate an output data set of the same dimension as the input dataset, wherein the previously defective data fields have been filled out, whereas the non-defective data fields are left unchanged.

The discriminating network receives the output data sets of the generating network as well as a hint matrix which indicates at least partially some values of the output data sets input into the generating network which have been imputed by the generating network. Thus, in Yoon et al., unlike in conventional GANs, the discriminator is not provided with completely real, or completely fake (imputed, generated) data, but with a data set with some components that are real and some that are imputed.

By the definition of the hint matrix, the amount of information about the deficient data fields can be controlled, ranging between the extremes of a hint matrix that does not give any indication about any of the data fields and a hint matrix that clearly identifies all defective data fields and all non-defective data fields as such. In the latter case, the discriminator would quickly learn to disregard the output set completely and focus exclusively on the information provided by the hint matrix. A careless setting of the hint matrix can thus have the effect that the discriminator learns to “cheat”, i.e. to fulfil its task without actually judging the quality of the data imputation by the generating network. In that case, the generating network cannot significantly improve and thus remains at suboptimal efficiency.

### SUMMARY

Thus, it is an object of the present invention to provide an improved method for providing an artificial neural network for data imputation and an improved corresponding system.

Therefore, according to a first aspect of the present invention, a computer-implemented method for providing an artificial neural network for data imputation is provided, comprising at least the steps of:

obtaining original data sets, each original data set comprising a plurality of data fields,

wherein each original data set may have a number of deficient data fields, wherein a deficient data field is a data field which is left empty or which is filled with a placeholder, and

wherein at least one of the plurality of data fields is a categorical data field, wherein a categorical data field is a data field which is configured to only comprise, as field values, vectors whose entries are limited to a respective finite set of discrete values;

providing deficiency data for each input data set, wherein the deficiency data indicate which data fields of the corresponding original data set are deficient data fields;

preparing input data sets based on the original data sets, wherein in the input data sets each vector entry in a non-deficient categorical data field is replaced by a replacement value,

wherein at least one replacement value of each non-deficient data field is generated using a sampling algorithm applied to a sampling range, wherein the sampling range from for the vector entry to be replaced is determined based on the vector entry to be replaced;

providing a generating artificial neural network, GANN, configured to:

receive one of the input sets and the corresponding deficiency data;

generate, based on said input data set and the deficiency data, a corresponding intermediate data set;

generating output data sets by replacing, in each intermediate data set, all field values of data fields that were not deficient data fields in the original data sets with their corresponding field values from the input data sets;

generating at least one output data set using the GANN;

providing a discriminating artificial neural network, DANN, configured to receive as one of its inputs an output data set of the GANN or an original data set and to determine, for each data field of the received output data set or original data set whether it has been generated by the GANN; and

training the GANN and the DANN in an adversarial way in a generative adversarial network, GAN, framework; and

providing the trained GANN as at least part of an artificial neural network for data imputation.

The original data sets may in particular real HER data, i.e. patient data. The original data sets may comprise complete original data sets (i.e. data sets without deficient data fields, or, in other words, wherein all data fields are filled in), as well as incomplete (or deficient) data sets in which at least some data fields are deficient).

In general, a data field should be understood herein to be realized by a tensor, preferably a matrix more preferably a vector, the entries of which encode information.

For example, one data field may refer to the sex of a data owner, e.g. a patient. Such a data field could be represented by a 1-dimensional vector (0: male, 1: female, or vice versa) or by a two-dimensional one-hot vector, wherein each entry indicates whether the data owner has a specific sex (e.g. [1, 0] indicating female and [0, 1] indicating male).

A one-hot vector is a vector that comprises a single One and otherwise Zeros and is usually used to categorize a data field in one of a plurality of mutually exclusive classes.

A multi-hot vector, by contrast, is vector that may comprises only Ones or Zeros (or, in other words, whose entries are limited to binary values, i.e. a set of two discrete values) but which may comprise a plurality of each. Multi-hot vectors are usually used to categorize a data field regarding a plurality of mutually non-exclusive classes. For example, each entry of the multi-hot vector may refer to a specific organ, and the value of each entry may encode whether that organ has been diagnosed with a certain affliction.

For improved intelligibility, when a “defective data field” is mentioned, it shall be understood that this is firstly a defective data field of an input data set, but that this will sometimes also indicate a data field in an intermediate data set or in an output dataset to which data imputation has been applied, or, in other words, to a data field that is the same data field (although now with actual, imputed values) as a data field that was a deficient data field in the input data set from which the intermediate data set or output data set has been generated.

The method may be prepared such that a data set is considered as deficient only when it is left completely empty or is completely filled with a placeholder. Alternatively, the method may be prepared such that a data set is considered as deficient also when it is a multi-hot vector and one of its entries is left empty or is filled with a placeholder. This may be the case, for example, when a specific exam is still ongoing, or when there are contradicting indications.

For the sampling, any known sampling algorithm may be used, in particular any randomizing or pseudo-randomizing algorithm.

The GAN framework may be provided as in Goodfellow et al., and in particular as in Yoon et al.

Providing the trained GANN as “at least part of an artificial neural network” for data imputation should be understood in particular to mean that said GANN may be the one and only part, i.e. may be itself, the artificial neural network for data imputation, or it may be augmented by further pre- and/or postprocessing steps in a pipeline to form the final artificial neural network for data imputation. However, in any case, the trained GANN will be the core portion of the artificial neural network for data imputation in any case.

The method according to the first aspect is based at least on the findings of the inventors that the discriminating network, in a GAN framework set up as e.g. in Yoon et al., receives implicit hints from the output data sets about which data fields are non-deficient data fields: since artificial neural networks usually generate output by non-linear activation functions such as ReLu, Softmax, sigmoid and the like, it is essentially excluded that the generating neural network will provide data fields with exact values such as One or Zero, as they are usually used for categorization in data fields. For example, a Softmax function that is very certain that the data field it describes should be categorized into the category (one of three) indicated by the first entry of a vector may produce a vector like [0.95, 0.03, 0.02] but it will never produce a vector like [1, 0, 0].

The inventors have discovered that, surprisingly, the discriminating networks learn to distinguish “clean” binary values (Zeros and Ones) as “original”/“real”, and values in between as “imputed”/“generated”/“fake”. Thus, the present invention limits information about the possible deficient data fields to a hint vector, if it is provided, and otherwise forces the discriminating network to actually learn to distinguish imputed values from original ones based on the data themselves. Thus, the training effect of the method is greatly improved in comparison to previously known alternatives.

In some advantageous embodiments, variants, or refinements of embodiments, one of the categorical data fields, a plurality of the categorical data fields or all of the categorical data fields are configured to only comprise vectors whose entries are limited to Zero and One. In particular, one, any, or all of the categorical data fields may be one-hot vectors and/or multi-hot vectors.

In some advantageous embodiments, variants, or refinements of embodiments, for categorical data fields that comprise one-hot vectors of dimension q, the replacement values for each element of the one-hot vector are determined as follows:

vector entries of Zero within the one-hot vector are replaced by a value sampled from the range of Zero to 1/q, wherein Zero is included and 1/q is excluded; and

the single vector entry of One within the one-hot vector is replaced by a value in the range of 1/q to 1, both included, in particular by the value of One minus the sum of the replacement values for the vector entries of Zero.

In this way, the information is still easily retrievable from the data fields, in that every value lower than 1/q corresponds to a previous Zero, and the value larger than 1/q corresponds to a previous One. However, to the discriminating network, the underlying rule is unknown and so it is forced to find other ways to determine “original” from “imputed”.

In some advantageous embodiments, variants, or refinements of embodiments, for categorical data fields that comprise multi-hot vectors of dimension q, the replacement values for each element of the multi-hot vector are determined as follows:

vector entries of Zero within the multi-hot vector are replaced by a value sampled from the range of Zero to a predefined value T, wherein Zero is included and T is excluded; and

vector entries of One within the multi-hot vector are replaced by a value sampled from the range of the predefined value T to One, wherein both T and One are included.

Preferably, T is equal to one half, i.e. 0.5. Since again to the discriminating network the underlying rule is unknown and so it is forced to find other ways to determine “original” from “imputed”. For example, knowing the rule, it is evident that 0.49 indicates a previous Zero and 0.51 indicates a previous One, but the discriminating network will at first have to assume that these two close values indicate similar properties of the data field.

Similarly, in some advantageous embodiments, variants, or refinements of embodiments, for categorical data fields that comprise multi-hot vectors of dimension q, the replacement values for each element of the multi-hot vector are determined as follows:

vector entries of Zero within the multi-hot vector are replaced by a value sampled from the range of Zero to a predefined value T, wherein both Zero and T are included; and vector entries of One within the multi-hot vector are replaced by a value sampled from the range of the predefined value T to One, wherein T is excluded and One is included.

Also in this case, preferably T is equal to one half, i.e. 0.5.

In some advantageous embodiments, variants, or refinements of embodiments, the deficiency data are encoded as deficiency vectors with binary entries (i.e. all entries are either Zero or One), wherein a first binary value (e.g. Zero) as a deficiency vector entry indicates a data field to be a deficient data field or indicates a vector entry of a data field to be a vector entry of a deficient data field, and the second binary value (e.g. One) as a deficiency vector entry indicates a data field to be a non-deficient data field or, respectively, indicates a vector entry of a data field to be a vector entry of a non-deficient data field.

In other words, the deficiency data may be encoded by a binary entry for each data field, or by a binary entry for each entry of a respective vector corresponding to the data field. The latter is preferred, as it allows to treat the individual entries separately, thus also forcing, or enabling, the discriminating network to do the same.

In some advantageous embodiments, variants, or refinements of embodiments, the method comprises the step of generating a hinting vector for each output data set, wherein the hinting vector comprises incomplete information about which data fields of the input data set corresponding to the output data set are deficient data fields (and preferably incomplete information about which individual entries of the vectors corresponding to the data fields are deficient or belong to a deficient data field). Then preferably the DANN receives, as another one of its inputs, for each output data set also the corresponding hinting vector. As has been described in Yoon et al., the hinting vector can be used to tune the difficulty for the discriminating network. However, in contrast to the prior art, in the present context the hinting vector provides much better control since other unintended hints (too “clean” entries of the vectors of the original data) are eliminated.

In some advantageous embodiments, variants, or refinements of embodiments, the hinting vector for an output data set is generated from the deficiency vector for the input data set corresponding to the output data set, wherein at least one vector entry is replaced by a numerical value between the first and the second binary value, preferably in the exact middle between the first and the second binary value. The number of vector entries being replaced is one tunable hyperparameter of the training method. Preferably, the first and the second binary values are Zero and One, or vice versa, and the numerical value is in between, and is most preferably equal to 0.5. The value directly in between (e.g. 0.5) corresponds to maximum ambiguity of the hint vector regarding a specific vector entry of a data field, or, in other words, this value indicates that the discriminating network has to find out by itself whether this value is original or imputed.

It may be defined that only vector entries having the first binary value are allowed to be replaced, or only those having the second binary value. It is also preferred that all entries of the deficiency vector belonging to the same data field are treated in the same way, i.e. are replaced all or none.

While the number of vector entries to be replaced by the numerical value is fixed, the specific vector entries which are replaced may be randomly chosen for each set input for training into the discriminating network anew, much as in the dropout technique connections between network nodes are randomly deactivated for each input example. In some variants, also the number of vector entries to be replaced may be chosen randomly within a predefined range.

According to a second aspect, the invention also provides a computing device configured to perform the method according to any embodiment of the method according to the first aspect of the present invention.

The computing device may be realized in hardware, such as a circuit or a printed circuit board and/or comprising transistors, logic gates and other circuitry. Additionally, the computing device may be at least partially realized in terms of software. Accordingly, the computing device may comprise a processor (such as at least one CPU and/or at least one GPU) and a memory storing a software or a firmware that is executed by the processor to perform the functions of the computing device.

The computing device may also be realized as a cloud computing platform.

In systems based on cloud computing technology, a large number of devices is connected to a cloud computing system via the Internet. The devices may be located in a remote facility connected to the cloud computing system. For example, the devices can comprise, or consist of, equipments, sensors, actuators, robots, and/or machinery in an industrial set-up(s). The devices can be medical devices and equipments in a healthcare unit. The devices can be home appliances or office appliances in a residential/commercial establishment.

The cloud computing system may enable remote configuring, monitoring, controlling, and maintaining connected devices (also commonly known as ‘assets’). Also, the cloud computing system may facilitate storing large amounts of data periodically gathered from the devices, analyzing the large amounts of data, and providing insights (e.g., Key Performance Indicators, Outliers) and alerts to operators, field engineers or owners of the devices via a graphical user interface (e.g., of web applications). The insights and alerts may enable controlling and maintaining the devices, leading to efficient and fail-safe operation of the devices. The cloud computing system may also enable modifying parameters associated with the devices and issues control commands via the graphical user interface based on the insights and alerts.

The cloud computing system may comprise a plurality of servers or processors (also known as ‘cloud infrastructure’), which are geographical distributed, connected with each other via a network. A dedicated platform (hereinafter referred to as ‘cloud computing platform’) is installed on the servers/processors for providing above functionality as a service (hereinafter referred to as ‘cloud service’). The cloud computing platform may comprise a plurality of software programs executed on one or more servers or processors of the cloud computing system to enable delivery of the requested service to the devices and its users.

One or more application programming interfaces (APIs) are deployed in the cloud computing system to deliver various cloud services to the users.

Further advantageous embodiments, variants, options and modifications are apparent from the dependent claims for each of the aspects of the invention as well as from the description in combination with the figures.

The invention further provides, according to a third aspect, a non-transitory computer-readable data storage medium comprising executable program code configured to, when executed by a computing device, perform the method according to any embodiment of the first aspect.

The invention further provides, according to a fourth aspect of the present invention, a non-transitory computer-readable data storage medium comprising an artificial neural network provided using the method according to the first aspect of the invention.

The invention also provides, according to a fifth aspect, a computer program product comprising executable program code configured to, when executed by a computing device, perform the method according to any embodiment of the first aspect.

The invention further provides, according to a sixth aspect of the present invention, a computer program product comprising an artificial neural network provided using the method according to the first aspect of the invention.

The invention further provides, according to a seventh aspect, a method for data imputation, comprising the steps of providing an artificial neural network for data imputation according to the method according to any embodiment of the first aspect of the invention; and using the provided artificial neural network (10) for data imputation.

The invention also provides, according to an eighth aspect, a data stream comprising, or configured to generate, executable program code configured to, when executed by a computing device, perform the method according to any embodiment of the first aspect.

The invention will be explained in yet greater detail with reference to exemplary embodiments depicted in the drawings as appended.

The accompanying drawings are included to provide a further understanding of the present invention and are incorporated in and constitute a part of the specification. The drawings illustrate the embodiments of the present invention and together with the description serve to illustrate the principles of the invention. Other embodiments of the present invention and many of the intended advantages of the present invention will be readily appreciated as they become better understood by reference to the following de-tailed description. Like reference numerals designate corresponding similar parts.

The numbering of method steps is intended to facilitate understanding and should not be construed, unless explicitly stated otherwise, or implicitly clear, to mean that the designated steps have to be performed according to the numbering of their reference signs. In particular, several or even all of the method steps may be performed simultaneously, in an over-lapping way or sequentially.

### BRIEF DESCRIPTION

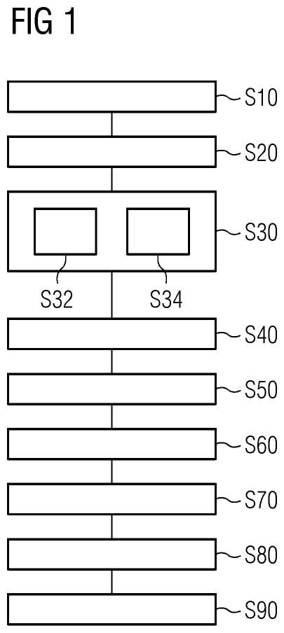

FIG. 1 schematically illustrates a flow diagram of an embodiment of the method according to the first aspect of the present invention;

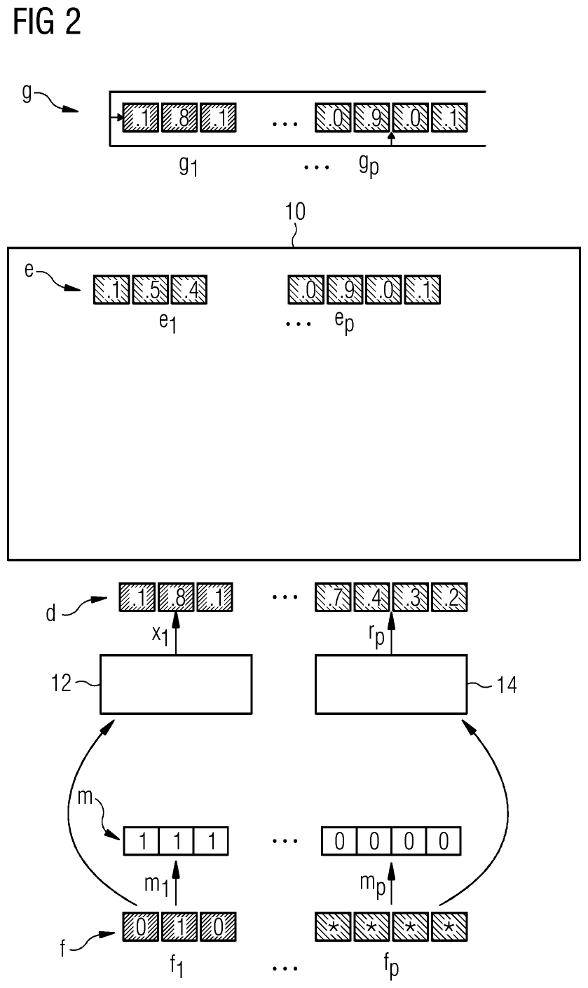

FIG. 2 schematically illustrates details and/or options for the method according to FIG. 1;

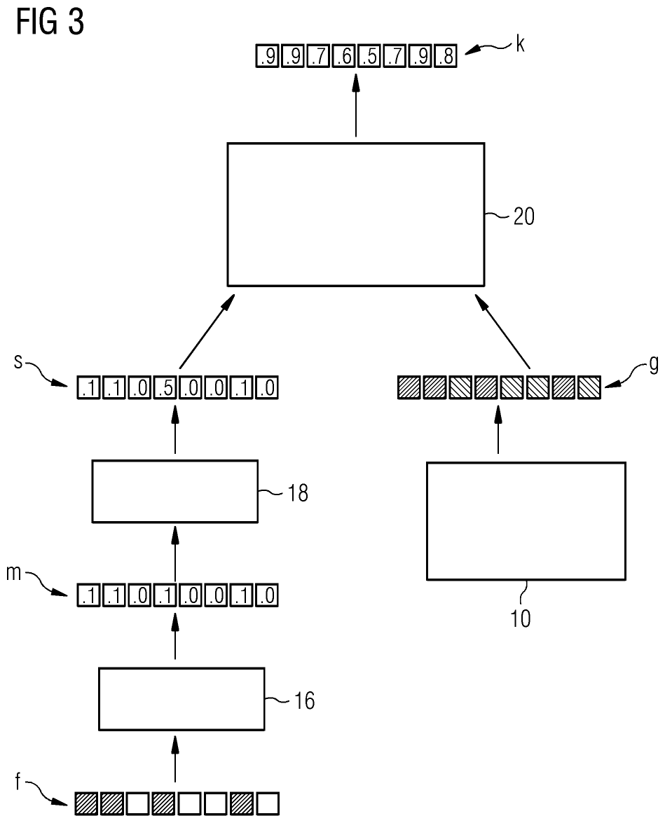

FIG. 3 schematically illustrates further details and/or options for the method according to FIG. 1;

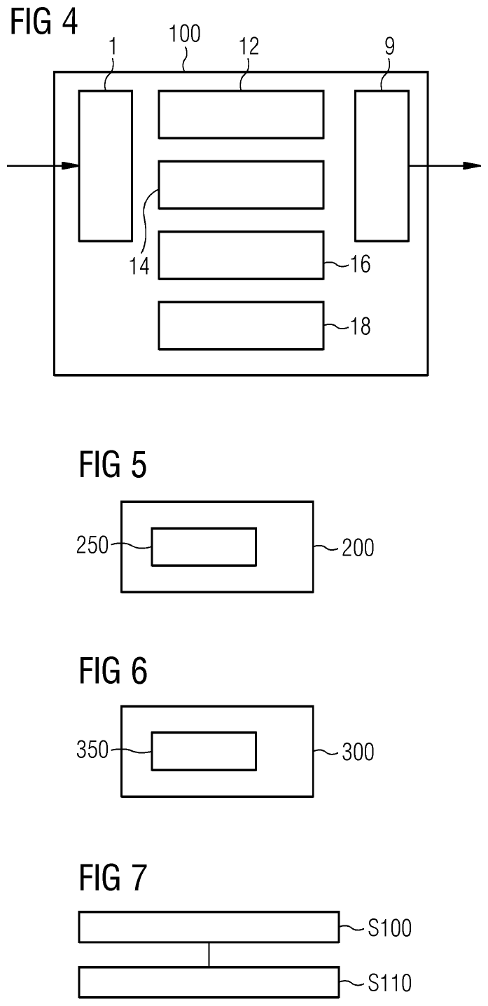

FIG. 4 shows a schematic block diagram schematically illustrating a computing device according to an embodiment of the second aspect of the present invention;

FIG. 5 shows a schematic block diagram of a data storage medium according to an embodiment of the third aspect of the present invention or according to an embodiment of the fourth aspect of the present invention;

FIG. 6 shows a schematic block diagram of a computer program product according to an embodiment of the fifth aspect of the present invention or according to an embodiment of the sixth aspect of the present invention;

FIG. 7 schematically illustrates a flow diagram for a method for data imputation according to the seventh aspect of the present invention.

Although specific embodiments have been illustrated and described herein, it will be appreciated by those of ordinary skill in the art that the variety of alternate and/or equivalent implementations may be substituted for the specific embodiments shown and described without departing from the scope of the present invention. Generally, this application is intended to cover any adaptations or variations of the specific embodiments discussed herein.

### DETAILED DESCRIPTION

FIG. 1 schematically illustrates a flow diagram of an embodiment of the method according to the first aspect of the present invention, i.e. a computer-implemented method for providing an (trained, or pre-trained) artificial neural network for data imputation.

The method of FIG. 1 is also explained with reference to FIG. 2 through 4 which schematically show concepts and structures employed in the method.

In a step S10, original data sets are obtained, e.g. received, each original data set comprising a plurality of data fields. The data sets may in particular comprise patient data, or EHR.

Obtaining the original data sets may comprise, or consist of, receiving the data sets from a Picture Archiving and Communication System, PACS, from a database, from a cloud computing server and/or the like. The data fields are preferably represented by vectors, wherein the dimensions of the vectors are chosen specifically for each data field. For example, a data field indicating a patient's sex may be represented by a two-entry one-hot vector, whereas a vector representing a data field indicating a blood type of a patient may have a lot more entries.

Each original data set may have a number of deficient data fields, wherein a deficient data field is a data field which is left empty or which is filled with a placeholder. For example, while the sex of the patient may be known, and be indicated by a [1, 0] or [0, 1] vector for the corresponding data field “patient sex”, the blood type of the patient may never have been measured. Thus, the data set may simply indicate that there are no values for the data field “patient blood type”, and the vector representing that data field may be comprised of placeholders, e.g. [?, ?, ?, , ?] or [*, *, *] or the like.

At least one of the plurality of data fields is a categorical data field, wherein a categorical data field is a data field which is configured to only comprise, as field values, vectors whose entries are limited to a respective finite set of discrete values. In other words, the vector entries can only be chosen from the finite set of discrete values. The most common and practical set of discrete values is he binary set of Zero and One (or “0” and “1”, or {0, 1} written as a set). However, in principle also other sets are possible.

The method is equally applicable to data sets which do not comprise such categorical data fields; however, the strengths of the method are most prominent in the case of categorical data fields, where in the prior art the discriminating network would receive additional hints from the sharp and discrete values in the vector entries of the data fields of the original data sets.

FIG. 2 schematically illustrates the concept within the first few steps of the method. In FIG. 2, an original data set f is illustrated which comprises p data fields designated as f₁, . . ., fₚ, wherein only the first and the p-th fields are shown for simplicity. The first data field f₁ is a categorical data field represented by a three-entry one-hot vector [0,1,0]. The p-th data field fₚ is a categorical data field that is deficient, i.e. no values are known, as indicated by the placeholders “*”, i.e. the p-th data field fₚ is represented by a four-entry vector [*, *, *, *].

In a step S20, a mask tensor m (here: a mask vector because the original data sets are arranged as vectors) is provided (for example received or generated). The mask tensor m is a specific example of deficiency data that indicate which data fields of the corresponding input data set are deficient data fields.

The mask tensor m is a concatenation of p individual tensors m₁, . . ., mₚ that each have the same size as a respective data field and which either comprise only Ones (1s) when the corresponding data field is non-deficient, or only Zeros (0s) when the corresponding data field is deficient. Thus, in the example of FIG. 2, the individual tensor mi corresponding to the first data field f₁ is a three-entry vector of only ls, and the individual tensor mₚ corresponding to the p-th data field is a four-entry vector of only 0s. The mask tensor m may be provided in step S20 automatically, e.g. by a missing value detector module (or: deficiency detector module) implemented e.g. as software by a computing device. The mask tensor m may also be simply provided along with the original data.

In a step S30, input data sets d are prepared (or: generated) based on the original data sets, wherein in the input data sets d each vector entry in a non-deficient categorical data field is replaced by a replacement value.

In a sub-step S32 of step S30, at least one replacement value of each non-deficient data field is generated using a sampling algorithm applied to a sampling range, wherein the sampling range from for the vector entry to be replaced is determined based on the vector entry to be replaced. Step S32 may be performed by a fuzzy coding module 12 implemented as software by a computing device. The fuzzy coding module 12 can also be designated as a smoothing module, or as a smoother, as it produces more generated-looking, smoother values instead of harsh values such as flat 0 or flat 1.

In particular, for categorical data fields that comprise one-hot vectors of dimension q, the replacement values for each element of the one-hot vector are determined as follows:

vector entries of Zero within the one-hot vector are replaced by a value sampled from the range of 0 to 1/q, wherein 0 is included and 1/q is excluded; and

the single vector entry of 1 within the one-hot vector is replaced by 1 minus the sum of the replacement values for the vector entries of 0.

Thus, in the example of FIG. 1, in the non-deficient first data field f1, the two 0s are replaced by a value of 0.1 sampled from the range from 0 to 0.5, with 0 included and 0.5 excluded, and then the one 1 of the one-hot vector f1 is replaced by 1-0.1-0.1=0.8. Note that one sampling may be performed, and all 0s of the same data field fᵢ may then be replaced by that sampled value, or one sampling for each 0 may be performed.

Similarly, for categorical data fields (not illustrated in FIG. 2) that comprise multi-hot vectors of dimension q, the replacement values for each element of the multi-hot vector would be determined as follows:

vector entries of 0 within the multi-hot vector are replaced by a value sampled from the range of 0 to a predefined value T, wherein 0 is included and T is excluded, and

vector entries of 1 within the multi-hot vector are replaced by a value sampled from the range of the predefined value T to 1, wherein both T and 1 are included, with preferably T=0.5

In a further sub-step S34 of step S30, the missing values in the deficient data fields (in FIG. 2 p-th data field fₚ) are replaced by number, preferably by a seed sampling module 14 (implemented by a computing device) which produces in each case some random real number that serves as initial value for the missing value. The sampling may be performed e.g. based on a unified or a Gaussian distribution. After training, one could draw random samples from the distribution and feed them to the generating network, which is the most essential mechanism that allows for multiple imputation.

In FIG. 2, the vector x₁ (of the input data set d) representing non-deficient data field f₁ after step S32 reads [0.1, 0.8, 0.1], whereas a vector rₚ for the deficient data field fₚ after step S34 is filled with random real numbers e.g. as [0.7, 0.4, 0.3, 0.2]. At this point it is quite evident that there is no immediately discernible difference between the entries of the vectors xi for the non-deficient data fields and the entries of the vectors rᵢ for the deficient data fields (wherein deficiency and non-deficiency refers, as always, to the original data sets f). In other words, although the xᵢ comprise values known with certainty, to the discriminating network they will look like the output of a softmax function.

In a step S40, a generating artificial neural network, GANN 10, is provided which is configured (and optionally pre-trained) to:

receive one of the input sets d and the corresponding deficiency data (here: the mask vector m);

generate, based on said input data set d and the deficiency data m, a corresponding intermediate data set e.

Just as the mask tensor and the input data set d, the intermediate data set e is made up of concatenated vectors eᵢ, each of which has the same dimension/size as, and corresponds to, a respective vector fᵢ representing one of the data fields.

As shown in FIG. 2, for example the GANN would provide a vector eᵢ=[0.1, 0.5 0.4] for the first data field f1, and a vector eₚ=[0, 0.9, 0.0, 0.1] for the p-th data field, and of course also vectors eᵢ for 1<i<p. Note that eₚ is desired, as it contains the imputed values for the deficient p-th data field, whereas el is useless, as f₁ of the original data set f already contains the known correct values.

Thus, in a step S50, output data sets g are generated by replacing, in each intermediate data set d, all field values (here: entries of eᵢ) of data fields that were non-deficient data fields (here: first data field) in the original data sets f with their corresponding field values (here: entries of f₁) from the input data sets d. It is preferred that the GANN 10 is configured to perform this step S50 as well, although it could also be performed as a separate step in a pipeline after the GANN 10.

Thus, in the output data sets g, the non-deficient data fields have the same values as in the input dataset d, whereas the deficient data fields have the same values as in the intermediate data set e.

Note that the GANN 10 will, after training, be provided as the artificial neural network for data imputation, or as part of said artificial neural network for data imputation. In the latter case, for example, a layer or algorithm could be added that replaced the “fuzzy” values again by the actual “clean values”, i.e. undoes the replacement rules set out above. For example, g₁=[0.1, 0.8, 0.1] could be replaced by [0, 1, 0] again (restoring f₁), whereas gₚ=[0.0, 0.9, 0.0, 0.1] could be replaced by [0, 1, 0, 0], taking into account in each case whether the corresponding data field is represented by a one-hot vector or by a multi-hot vector. If step S50 is performed separately from the GANN 10, then for the purpose of adversarial training, step S50 may be performed on the outputs of the GANN 10, whereas in the inference stage, when the trained GANN 10 is employed for actual data imputation, step S50 may be replaced by a step of replacing all field values (here: entries of e₁) of data fields that were non-deficient data fields (here: first data field) in the original data sets f with their corresponding field values (here: entries of f₁) from the original data sets f This abbreviates the procedure of first replacing (in this example) e₁ by x₁ and then retrieving f₁ from x₁ (by undoing the replacement generating x₁ from f₁).

In one particularly effective example and embodiment, the GANN 10 comprises three hidden layers h^{G}₁, h^{G}₂, h^{G}₃, defined as follows, wherein the superscript G indicates layers of the GANN 10:

h₁^{G}=relu(W₁^{G}.[x̅+(1−m̅) o r̅, m̅]+b₁^{G})

h₂^{G}=relu(W₂^{G}.h₁^{G}+b₂^{G})

h₂^{G}=relu(W₃^{G}.h₂^{G}+b₃^{G})

gⱼ=σ(Wₒ^{H}(j).h₃^{G}+bₒ^{G}(j))∀ⱼ∈[1,p]

g̅=m̅o x̅+(1−m̅) o [gⱼ]^{p}ⱼ₌₁

Herein, relu indicates the rectified linear unit, x corresponds to the input data set d with vectors full of only 0s replacing all rᵢ, r corresponds to the input data set with vectors full of only 0s replacing all xᵢ, m indicates the mask tensor, [a,m] denotes a concatenation of a with m, Wᵢ indicate trainable weight matrices, bᵢ indicate trainable bias vectors, σ indicates the sigmoid function (for multi-hot vectors) or the softmax function (for one-hot vectors), respectively, and “o” indicates an element-wise multiplication.

Thus, the hidden layers hᵢ extract hierarchically global context information from the input data sets d (composed of the xᵢ and the rᵢ).

In a step S60, a discriminating artificial neural network, DANN is provided which is configured to receive as one of its inputs an output data set g or an original data set f and to determine, for each data field of the received output data set g (or of the received original data set f, respectively) whether it has been generated by the GANN 10.

Step S60 and following are illustrated not only in FIG. 1 but also in FIG. 3. In FIG. 3, it is shown again how, in step S20, the mask tensor m (here: mask vector m) is generated, e.g. by a missing value detector module 16 implemented as software by a computing device.

In FIG. 3, for the sake of an improved overview only the data fields of the original data set f are illustrated and not the individual entries of the vectors representing the data fields (here: 8 data fields). Filled-out squares represent non-deficient data fields (here: first, second, fourth and seventh data field), whereas empty squares represent deficient data fields (here: third, fifth, sixth and eight data fields). In the depiction of the mask vector m, a squared 1 indicates a vector comprising only 1s, having the same dimension as the corresponding vector representing the corresponding data field of the original data set f, and a squared 0 indicates a vector comprising only 0s, having the same dimension as the corresponding vector representing the corresponding data field of the original data set f.

In a step S70, based on the mask vector m, a hint sampling module 18 generates a hinting vector s by replacing the values of at least one of the vectors comprising only 1s by a vector of the same size comprising only values of 0.5. as has been described in the foregoing, the number of vectors replaced in this way may be a hyperparameter or may be randomly determined, and in any case the data fields (out of the non-deficient data fields) whose entries are replaced may be randomly chosen. In the present example, the fourth data field has been chosen. Thus, the hinting vector s is the same as the mask vector m except that the vector for the fourth data field which comprised only 1s in the mask vector m instead only comprises values of 0.5 in the hinting vector s.

The DANN 20 is configured such that it takes, as its input, an output data set g of the GANN 10 and a corresponding hinting vector s (preferably g and s concatenated), and outputs a discriminating vector k which indicates for each data field an estimated likelihood that the values in said data field have been generated by the GANN 10 (as opposed to being values of the original data set f).

In one particularly effective example and embodiment, the DANN 20 comprises three hidden layers h^{D}₁, h^{D}₂, defined as follows, wherein the superscript D indicates layers of the DANN 20:

$${h}_{1}^{D} = relu ( {W}_{1}^{D} \cdot [ \overline{g} , \overline{h} ] + {b}_{1}^{G} )$$

$${h}_{2}^{D} = relu ( {W}_{2}^{D} \cdot {h}_{1}^{D} + {b}_{2}^{D} )$$

$$\begin{matrix}{\hat{y}}_{j} = σ ( {{W}_{0}^{D} ( j )}^{T} \cdot {h}_{3}^{G} + {b}_{0}^{D} ( j ) ) ∀ j ∈ [ 1 , p ] \\ = ( {\overline{x}}_{j} is real )\end{matrix}$$

wherein the double-lined capital P indicates a probability. In a step S80, the GANN 10 and the DANN 20 are trained in an adversarial way in a generative adversarial network, GAN, framework. Step S70 may be performed anew (either online or preprepared) for each output set g of the GANN 10 being input into the DANN 20, i.e. for each output set g potentially one or more different data fields are chosen whose values are to be replaced with 0.5.

Training S80 the GANN 10 and the DANN 20 may be performed e.g. as has been described in Goodfellow et al. or Yoon et al., in particular alternatingly until the DANN 20 is unable to detect imputed values with any certainty. In particular, loss functions as described in Yoon et al. may be used, i.e.

loss_{D}=Σⱼ(μⱼ.log(\hat{μ}ⱼ)+(1−μⱼ).log(1−\hat{μ}ⱼ))

loss_{G}=Σⱼ(1−μⱼ).log(\hat{μ}ⱼ)

wherein the subscript D and G refers to DANN 20 and GANN 10, respectively, and wherein μⱼ indicates whether data field j is deficient (i.e. its values have been imputed), and wherein the hat “∧” indicates the corresponding prediction for μⱼ output by the DANN 20.

In a step S90, after training S80 has been performed until the accuracy of DANN 20 and/or GANN 10 reaches a respectively defined target value, the GANN 10 is provided, either by itself or in combination with further steps in a pipeline, as an artificial neural network for data imputation.

FIG. 4 shows a schematic block diagram of a computing device 100 according to an embodiment of the second aspect of the present invention. The computing device 100 is configured to perform the method according to any embodiment of the first aspect of the present invention, in particular to perform the method as has been described with respect to FIG. 1 to FIG. 3 in the foregoing and/or any variation or modification thereof.

Thus, the computing device 100 may comprise a fuzzy coding module 12, a seed sampling module 14, a missing value detector module 16 and/or a hint sampling module 18 as have been described in the foregoing and/or in Yoon et al. The computing device 100 may further be provided with an input interface 1 for receiving data such as the original data sets f, potentially some or all mask vectors m and/or the like. The computing device may further be provided with an output interface 9 for outputting data such as the trained GANN 10 (or, respectively, trained weights and biases representing the trained GANN 10).

FIG. 5 shows a schematic block diagram of a non-transitory, computer-readable data storage medium 200 according to an embodiment of the third aspect of the present invention, i.e. a non-transitory-computer-readable data storage medium 200 comprising executable program code 250 configured to, when executed by a computing device 100, perform the method according to FIG. 1 to FIG. 3.

FIG. 5 also illustrates a non-transitory, computer-readable data storage medium 200 according to the fourth aspect of the present invention, i.e. a data storage medium 200 comprising an artificial neural network 10 provided using the method according to the first aspect of the invention, in particular according to the method as described with respect to FIG. 1 to FIG. 3.

FIG. 6 shows a schematic block diagram of a computer program product 300 according to an embodiment of the fifth aspect of the present invention, i.e. a computer program product 300 comprising executable program code 350 configured to, when executed by a computing device 100, perform the method according to FIG. 1 to FIG. 3.

FIG. 6 also illustrates a computer program product 300 according to the sixth aspect of the present invention, i.e. a computer program product 300 comprising an artificial neural network 10 provided using the method according to the first aspect of the invention, in particular according to the method as described with respect to FIG. 1 to FIG. 3.

FIG. 7 schematically illustrates a flow diagram for a method for data imputation according to the seventh aspect of the present invention, i.e. a method for data imputation.

In a step S100, an artificial neural network 10 for data imputation is provided using any embodiment of the method according to the first aspect of the invention, in particular as has been described with respect to FIG. 1 to FIG. 3.

In a step S110, the provided artificial neural network (10) is used for data imputation.

In the foregoing detailed description, various features are grouped together in the examples with the purpose of streamlining the disclosure. It is to be understood that the above description is intended to be illustrative and not restrictive. It is intended to cover all alternatives, modifications and equivalence. Many other examples will be apparent to one skilled in the art upon reviewing the above specification, taking into account the various variations, modifications and options as described or suggested in the foregoing.

In a short summary, the present invention provides an improved method for providing an artificial neural network 10 for data imputation using a generative adversarial network framework. Binary values in categorizing data fields of original data sets are replaced with smoothed-out values that include a degree of randomization but from which the original information can be retrieved. In this way, unintended hints to the discriminating network are minimized and thus the performance of the generative network 10 as an artificial neural network for data imputation is improved.

### REFERENCE SIGNS

1 input interface

9 output interface

10 generating artificial neural network

12 fuzzy coding module

14 seed sampling module

16 missing value detector module

18 hint sampling module

20 discriminating artificial neural network

100 computing device

S10 ... S110 Method

200 data storage medium

250 program code

300 computer program product

350 program code

f original data sets

m mask vector

d input data sets

e intermediate data sets

g output data sets

s hinting vector

k discriminating vector

1. A computer-implemented method for providing an artificial neural network for data imputation, comprising at least the steps of:
obtaining original data sets, each original data set comprising a plurality of data fields,
wherein each original data set may have a number of deficient data fields, wherein a deficient data field is a data field which is left empty or which is filled with a placeholder, and
wherein at least one of the plurality of data fields is a categorical data field, wherein a categorical data field is a data field which is configured to only comprise, as field values, vectors whose entries are limited to a respective finite set of discrete values;
providing deficiency data for each input data set, wherein the deficiency data indicate which data fields of the corresponding original data set are deficient data fields;
preparing input data sets based on the original data sets, wherein in the input data sets each vector entry in a non-deficient categorical data field is replaced by a replacement value,
wherein at least one replacement value of each non-deficient data field is generated using a sampling algorithm applied to a sampling range, wherein the sampling range from for the vector entry to be replaced is determined based on the vector entry to be replaced;
providing a generating artificial neural network, GANN, configured to:
receive one of the input sets and the corresponding deficiency data;
generate, based on said input data set and the deficiency data, a corresponding intermediate data set;
generating output data sets by replacing, in each intermediate data set, all field values of data fields that were not deficient data fields in the original data sets with their corresponding field values from the input data sets;
generating at least one output data set using the GANN;
providing a discriminating artificial neural network, DANN, configured to receive as one of its inputs an output data set of the GANN or an original data set and to determine, for each data field of the received output data set or original data set whether it has been generated by the GANN; and
training the GANN and the DANN in an adversarial way in a generative adversarial network, GAN, framework; and
providing the trained GANN as at least part of an artificial neural network for data imputation.

2. The method of claim 1, wherein one of the categorical data fields, a plurality of the categorical data fields or all of the categorical data fields are configured to only comprise vectors whose entries are limited to Zero and One.

3. The method of claim 1, wherein for categorical data fields that comprise one-hot vectors of dimension q, the replacement values for each element of the one-hot vector are determined as follows:
vector entries of Zero within the one-hot vector are replaced by a value sampled from the range of Zero to 1/q, wherein Zero is included and 1/q is excluded; and
the single vector entry of One within the one-hot vector is replaced by One minus the sum of the replacement values for the vector entries of Zero.

4. The method of claim 1, wherein for categorical data fields that comprise multi-hot vectors of dimension q, the replacement values for each element of the multi-hot vector are determined as follows:
vector entries of Zero within the multi-hot vector are replaced by a value sampled from the range of Zero to a predefined value T, wherein Zero is included and T is excluded; and
vector entries of One within the multi-hot vector are replaced by a value sampled from the range of the predefined value T to One, wherein both T and One are included;
or determined as follows:
vector entries of Zero within the multi-hot vector are replaced by a value sampled from the range of Zero to a predefined value T, wherein both Zero and T are included; and
vector entries of One within the multi-hot vector are replaced by a value sampled from the range of the predefined value T to One, wherein T is excluded and One is included.

5. The method of claim 4, wherein T=0.5.

6. The method of claim 1, wherein the deficiency data are encoded as deficiency vectors with binary entries, wherein a first binary value as a deficiency vector entry indicates a data field to be a deficient data field or indicates a vector entry of a data field to be a vector entry of a deficient data field, and the second binary value as a deficiency vector entry indicates a data field to be a non-deficient data field or, respectively, indicates a vector entry of a data field to be a vector entry of a non-deficient data field.

7. The method of claim 1, comprising:
generating a hinting vector for each output data set, wherein the hinting vector comprises incomplete information about which data fields of the input data set corresponding to the output data set are deficient data fields;
wherein the DANN receives, as another one of its inputs, for each output data set also the corresponding hinting vector.

8. The method of claim 6, wherein the hinting vector for an output data set is generated from the deficiency vector for the input data set corresponding to the output data set, wherein at least one vector entry is replaced by a numerical value between the first and the second binary value.

9. The method of claim 8, wherein the first and the second binary values are Zero and One, or vice versa, and wherein the numerical value is 0.5.

10. A computing device configured to perform the method according to claim 1.

11. A non-transitory, computer-readable data storage medium comprising executable program code configured to, when executed, perform the method according to claim 1.

12. A computer program product comprising executable program code configured to, when executed, perform the method according to claim 1.

13. A non-transitory, computer-readable data storage medium comprising an artificial neural network provided using the method according to claim 1.

14. A computer program product comprising an artificial neural network provided using the method according to claim 1.

15. A method for data imputation, comprising:
providing an artificial neural network for data imputation according to the method according to claim 1; and
using the provided artificial neural network for data imputation.
